(19) United States
(12) Patent Application Publication
(10) Pub. No.: US 2006/0209882 A1
(43) Pub. Date: Sep. 21, 2006

(54) Method for vertical handoff in a hierarchical network

(76) Inventors: Seung-Jae Han, Basking Ridge, NJ (US); Thierry E. Klein, Fanwood, NJ (US)

Correspondence Address: WILLIAMS, MORGAN & AMERSON, 10333 RICHMOND, SUITE 1100, HOUSTON, TX, 77042, US

(21) Appl. No.: 11/068,026

(22) Filed: Feb. 28, 2005

(51) Int. Cl. H04J 3/22

(52) U.S. Cl. 370/465

(57) ABSTRACT

The present invention provides a method for wireless telecommunication using a wireless telecommunications network that includes a mobile unit and first and second wireless connection points. The first and second wireless connection points are communicatively coupled. The method includes forming a first wireless communication link between the mobile unit and the first wireless connection point and forming, concurrently with the first wireless communication link, a second wireless communication link between the mobile unit and the second wireless connection point. The method also includes selecting at least one of the first and second wireless communication links.

### BACKGROUND OF THE INVENTION

1. Field of the Invention

This invention relates generally to telecommunications systems, and, more particularly, to wireless telecommunications systems.

2. Description of the Related Art

Wireless telecommunications systems may be used to connect mobile units (sometimes also referred to as user equipment or UE) to a network using an air interface. Mobile units may include mobile phones, personal data assistants, smart phones, text messaging devices, laptop computers, desktop computers, and the like. For example, a mobile phone may be used to form a communication link over an air interface that operates according to a Code Division Multiple Access (CDMA2000) Evolution-Data-Optimized (EV-DO) standard or a Universal Mobile Telecommunication Systems (UMTS) standard. For another example, a wireless-enabled laptop computer may connect to the Internet by forming a communication link with an access point over an air interface that operates according to an IEEE 802.11 standard. Many mobile units are capable of communicating with more than one type wireless telecommunications system. For example, a dual-radio smart phone may include network interfaces for an EV-DO network and an IEEE 802.11 network.

Despite the proliferation of wireless technologies, no single technology meets all the potential requirements of applications in the mobile units while also providing sufficient user mobility. Instead, different wireless technologies typically attempt to balance competing demands, e.g. for network capacity and a large coverage area. For example, wireless local area network (LAN) technology provides relatively high capacity over a relatively small range, but the range of access points in the wireless LAN may be too short to cover a large geographical area with reasonable infrastructure cost. In contrast, wide-area wireless technology, such as EV-DO or UMTS networks, may provide coverage to a relatively large area but may limit a per-user bandwidth to values that are typically much smaller than that of wireless LANs.

Overlay networks attempt to combine advantages of different wireless technologies in a single architecture. In the overlay network architecture, multiple layers of cells (each potentially using a different technology) form a hierarchical cell structure. For example, a simple two-layer wireless overlay network may be formed by using the IEEE 802.11 wireless LAN technology for relatively high-bandwidth/small-size cells at the bottom layer and a Third Generation (3G) cellular wireless technology may be used for relatively low-bandwidth/large-size cells at the top layer. Exemplary 3G cellular wireless technologies may include, but are not limited to, EV-DO networks, UMTS networks, and High Speed Downlink Packet Access (HSDPA) networks.

Wireless overlay network architectures are becoming increasingly important and widespread. Hotspot cells, such as IEEE 802.11 cells, are being deployed in places like airports, hotels, shopping malls, coffee shops, and the like. Umbrella coverage may then be provided via one or more 3G wide area cellular base stations, such as for example EV-DO or UMTS base stations. Typically, base stations and IEEE 802.11 hotspot access points use wireline connections such as a T1 or Ethernet for a backhaul link to the wired network. Hotspot services may also be provided in transportation systems such as commuter trains, buses, ferries, airplanes, and the like. Hotspots in transportation systems may be mobile and therefore the access points in the mobile hotspots may require wireless backhaul links. For example, the overlay network may include a wireless backhaul link between access points of the mobile hotspot cells and a base station (or node-B) of a 3G cellular network.

A dual-radio mobile unit may form wireless links with an access point in the hotspot or a base station in the 3G umbrella network. In some instances, dual-radio users may prefer to connect to the access point in the hotspot cell, which may then function as a gateway or relay to a base station in the 3G umbrella network. Such an indirect transmission path may be advantageous since the connection to the base station may not be as good as the connection to the gateway access point. In addition, the presence of the gateway access point may simplify call management in the 3G network. Indeed, if many mobile units attempt to link directly to the 3G base station, the 3G base station may not be able to efficiently set up and handle the call processing involved for all the mobile units. Deploying a gateway access point may offload some of that processing to the gateway access point, which looks like a single mobile unit to the 3G base station, thereby reducing the processing burden on the 3G base station.

A hotspot cell with a wireless backhaul connection can also serve as an aggregation point for multiple mobile units with dual-radios. Thus, the gateway access point may be able to achieve some statistical multiplexing gains by aggregating the mobile units, which may facilitate buffer management in the network. For example, the variability of the individual traffic streams may be significantly reduced, which facilitates the network management and leads to increased performance. For another example, packing efficiencies may be achieved at the Transmission Control Protocol (TCP) layer, which may allow the gateway access point to maintain a persistent TCP connection to the base station and avoid setting up, tearing down, and re-establishing connections for the different mobile units. The smoother aggregate stream of packets may not be exposed to the variability of the individual packet streams. Therefore some of the adverse effects in TCP, such as TCP slow start and timeouts, can effectively be avoided, leading to a larger aggregate system throughput.

However, conventional overlay networks do not provide a seamless mechanism for vertical handoff between layers of the overlay network. For example, a handoff of a mobile unit between an EV-DO base station and an IEEE 802.11 access point performed according to a Mobile-IP scheme typically does not maintain concurrent communication links between the mobile unit and the EV-DO base station and IEEE 802.11 access point. The signaling procedure of such conventional schemes is complex and the handoff tends to involve a relatively long delay. Oftentimes tunneling is also needed. Consequently, service interruptions may occur during the handoff. A CDMA cellular network may maintain multiple communication links during a soft handoff between cells, but the same data is transmitted over each leg of the two communication links and the received data is combined at a mobile unit or a radio network controller depending on the direction of the communication.

The present invention is directed to addressing the effects of one or more of the problems set forth above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the instant invention, a method is provided for wireless telecommunication using a wireless telecommunications network that includes a mobile unit and first and second wireless connection points. The first and second wireless connection points are communicatively coupled. The method includes forming a first wireless communication link between the mobile unit and the first wireless connection point and forming, concurrently with the first wireless communication link, a second wireless communication link between the mobile unit and the second wireless connection point. The method also includes selecting at least one of the first and second wireless communication links.

### BRIEF DESCRIPTION OF THE DRAWINGS

The invention may be understood by reference to the following description taken in conjunction with the accompanying drawings, in which like reference numerals identify like elements, and in which:

FIG. 1 shows one exemplary embodiment of a hierarchical wireless telecommunications system, in accordance with the present invention;

FIG. 2 conceptually illustrates an exemplary embodiment of a hierarchical wireless telecommunications system, in accordance with the present invention;

FIG. 3 conceptually illustrates one exemplary embodiment of a vertical handoff of a mobile unit from an EV-DO cell to a gateway, in accordance with the present invention;

FIG. 4A conceptually illustrates one exemplary embodiment of an 802.11 gateway that may be used for a downlink handoff, in accordance with the present invention; and

FIG. 4B conceptually illustrates one exemplary embodiment of an 802.11 gateway that may be used for an uplink handoff, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

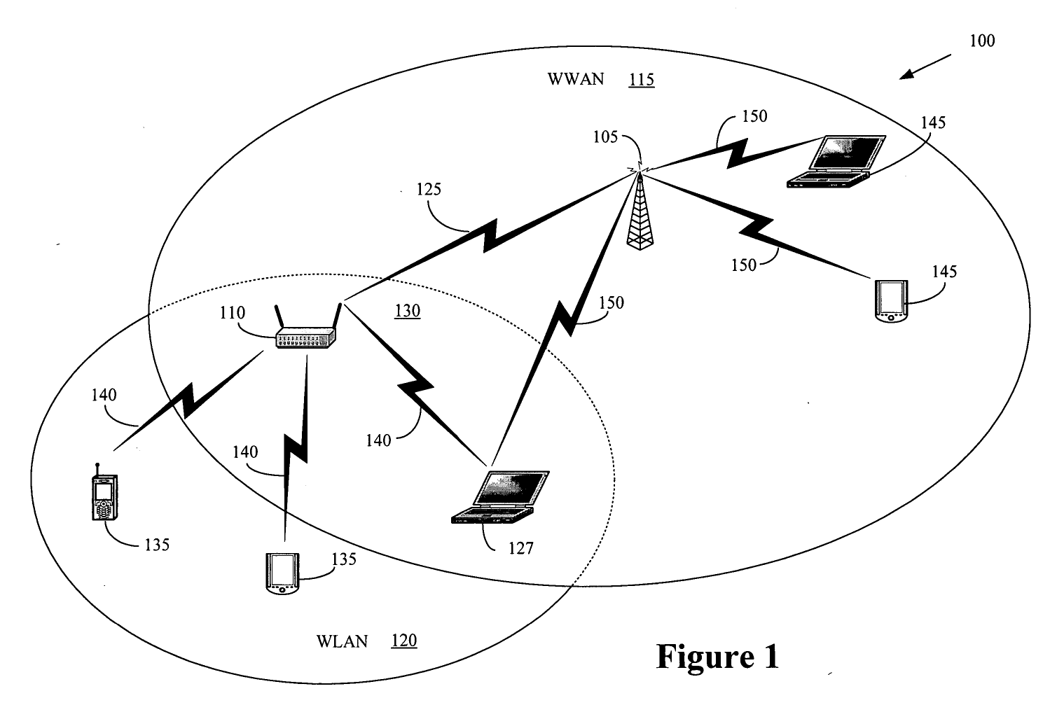

Referring now to FIG. 1, one exemplary embodiment of a hierarchical wireless telecommunications system 100 is shown. In the illustrated embodiment, the hierarchical wireless telecommunications system 100 is implemented according to an overlay network architecture in which two wireless connection points 105, 110 provide wireless connectivity to corresponding geographic areas 115, 120. The wireless connection points 105, 110 may form a wireless telecommunications link over an air interface 125. Alternatively, the wireless connection points 105, 110 may be communicatively coupled by a wired telecommunications link using a wireline (not shown). At least a portion of the geographic areas 115, 120 overlap so that devices (like mobile unit 127) in an overlapping region 130 may receive wireless connectivity via either of the two wireless connection points 105, 110. However, persons of ordinary skill in the art having benefit of the present disclosure should appreciate that the hierarchical wireless telecommunications system 100 may include any desirable number of wireless connection points that provide wireless connectivity to any desirable number of geographic areas.

In the illustrated embodiment, the wireless connection point 110 is an access point 110 that provides wireless connectivity to mobile units 135 (and the mobile unit 127) in a Wireless Local Area Network (WLAN) 120. Exemplary mobile units may include mobile phones, personal data assistants, smart phones, text messaging devices, laptops, and the like. The mobile units 127, 135 may form a wireless telecommunications link with the access point 110 over air interfaces 140. The air interfaces 140 may provide wireless connectivity to the wireless LAN 120 using any desirable protocol including, but not limited to, an IEEE 802.11 protocol, an IEEE 802.16 protocol, an IEEE 802.20 protocol, a Bluetooth protocol, and the like. In one embodiment, the access point 110 may be a fixed access point 110 such as may be deployed in an airport, a train station, a coffee shop, or any other desirable location. Alternatively, the access point 110 may be a mobile access point 110 such as may be deployed in an airplane, on a boat, on a train, or any other desirable mobile location.

The wireless connection point 105 shown in FIG. 1 is a CDMA2000 EV-DO (Evolution Data-Optimized) base station 105 that provides wireless connectivity to mobile units 145 in a Wireless Wide Area Network (WWAN) 115. The mobile units 145 (and the mobile unit 127) may form a wireless telecommunications link with the base station 105 over air interfaces 150. The air interfaces 150 may operate according to any desirable standard, including, but not limited to, a Universal Mobile Telecommunication System (UMTS) standard, a Global System for Mobile telecommunications (GSM) standard, a High Speed Downlink Packet Access (HSDPA) standard, and the like. Persons of ordinary skill in the art having benefit of the present disclosure should appreciate that the EV-DO base station 105 is merely one example of a base station that may be implemented according to the present invention. In alternative embodiments, any desirable type of wireless connection point may be used and may operate according to any desirable protocol.

The base station 105 may also provide wireless connectivity to the access point 110. In the illustrated embodiment, the air interface 125 provides a wireless backhaul link between the access point 110 and the base station 105. However, as noted above, the present invention is not limited to embodiments in which the base station 105 and access point 110 are communicatively connected by the air interface 125. In alternative embodiments, the base station 105 and access point 110 may be communicatively connected by a wireline connection such as a T1 connection or an Ethernet. The access point 110 may serve as a gateway and/or aggregation point for the mobile units 127, 135.

The mobile unit 127 may form concurrent communication links with the base station 105 and the access point 110 over the air interfaces 140, 150. Thus, one or more of the air interfaces 140, 150 may be selected. For example, the mobile unit 127 may select the air interface 140 by comparing channel conditions associated with the air interfaces 125, 150. However, the present invention is not limited to embodiments in which the mobile unit 127 performs the selection process. In alternative embodiments, the selection process may be performed by any desirable device or combination of devices, including the base station 105 and the access point 110. Moreover, the selection algorithm may be implemented in any desirable combination of hardware and/or software.

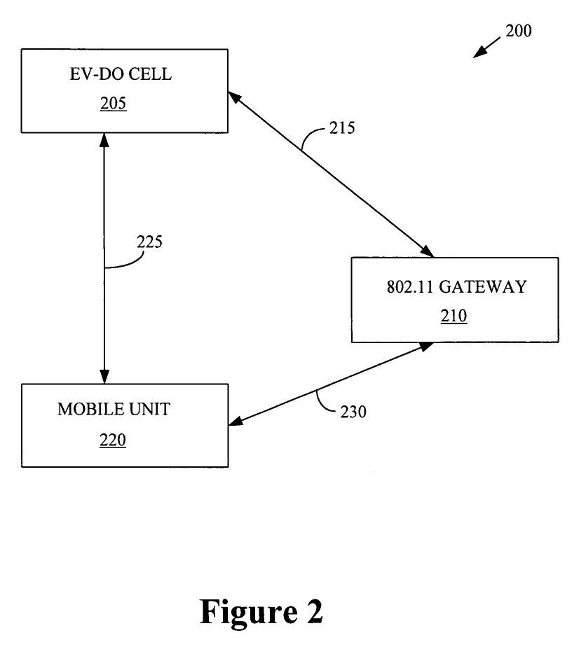

FIG. 2 conceptually illustrates an exemplary embodiment of a wireless telecommunications system 200. In the illustrated embodiment, the wireless telecommunications system 200 includes an EV-DO cell 205 that is communicatively coupled to an IEEE 802.11 gateway 210 via the communication link 215. A dual-radio mobile unit 220 is communicatively coupled to the EV-DO cell 205 and the gateway 210 by wireless telecommunications links 225, 230, respectively. As discussed above, the wireless telecommunications network 200 is intended to be illustrative and not to limit the present invention. Accordingly, other types of wireless connection points may be used in place of the EV-DO cell 205 and/or the 802.11 gateway 210, and the wireless telecommunications links 225, 230 may operate according to any desirable protocol.

The wireless telecommunications links 225, 230 may be formed and/or operated concurrently. For example, when the dual-radio mobile unit 220 boots up, it executes a conventional procedure to establish a connection with the EV-DO cell 205 in the network 200. This procedure performs functions such as authentication, registration, IP-address assignment, and the like. Once the connection setup to the EV-DO cell 205 is completed, the dual-radio mobile unit 220 may conduct a connection establishment procedure to the gateway 210 associated with a hotspot cell, if the dual-radio mobile unit 220 is located within the coverage area (i.e. the hotspot cell) of an IEEE 802.11 network. During the connection establishment procedure to the gateway 210, the dual-radio mobile unit 220 may be authenticated. In one embodiment, the dual-radio mobile unit 220 skips IP-address assignment for the 802.11 interface. Instead of getting a new IP address for its 802.11 link, the dual-radio mobile unit 220 uses the same IP address as its EV-DO interface for the 802.11 interface. In one embodiment, the traffic for the dual-radio mobile unit 220 initially runs over the EV-DO link 225 by default. If the dual-radio mobile unit 220 already has formed the wireless telecommunications link 225 with the EV-DO cell 205 when it enters the hotspot cell coverage, the dual-radio mobile unit 220 may conduct a connection establishment procedure with the corresponding 802.11 cell gateway 210. In one embodiment, similar to the procedure for booting up the dual-radio mobile unit 220, no IP address assignment is conducted during this procedure.

A cell selection algorithm may be executed after the concurrent wireless telecommunications links 225, 230 have been set up. In the illustrated embodiment, the cell selection algorithm is executed by the mobile unit 220. However, as discussed above, the cell selection algorithm may be executed by any desirable device or combination of devices. In one embodiment, the dual-radio mobile unit 220 queries the gateway 210 to determine the current channel condition associated with the telecommunications link 215 from the gateway 210 to the umbrella EV-DO cell 205. The dual-radio mobile unit 220 may then compare the channel quality information from the gateway 210 to the EV-DO cell 205 with a channel quality associated with the wireless telecommunications link 225 from the dual-radio mobile unit 220 to the EV-DO cell 205. In one embodiment, the dual-radio mobile unit 220 may switch its data traffic to the wireless telecommunications link 230 if the gateway 210 experiences higher EV-DO channel quality than that of the dual-radio mobile unit 220 on the wireless telecommunications link 225.

The embodiment described above implicitly assumes that the transmission rate over the wireless telecommunications link 230 between the dual-radio mobile unit 220 and the gateway 210 is much larger than the transmission rate on either of the EV-DO links 215, 225. Under this assumption, the achieved throughput between the dual-radio mobile unit 220 and the umbrella cell 205 is essentially a function of the throughput that can be achieved over the EV-DO links 215, 225. However, in other embodiments, the channel quality and the corresponding transmission rate between the dual-radio mobile unit 220 and the gateway 210 may also be taken into account when making the cell selection. Since the channel conditions change over time, the dual-radio mobile unit 220 may continuously monitor the channel quality information and change decisions dynamically. How frequently the switching can be done may be configurable. Moreover, in alternative embodiments, uplink and downlink selections may be treated separately, e.g., downlink traffic may go through the 802.11 gateway 210, while the uplink traffic may use the direct link 225 to the EV-DO cell 205.

Persons of ordinary skill in the art should appreciate that the selection algorithm may also be based on other factors. For example, the selection algorithm may consider a battery level at the dual-radio mobile unit 220 and/or backlog and loading information at the 802.11 gateway 210 and the EV-DO cell 205. In one embodiment, the EV-DO scheduler provides quality of service (QoS) support, so that the 802.11 gateway 210, which may support multiple mobile units 220, may be assigned a higher priority and therefore receive a higher bandwidth than individual mobile units. Although the exact behavior depends on the QoS scheme employed, the selection algorithm may consider the impact of the QoS schemes employed at the umbrella EV-DO cell 205. For example, the selection algorithm may consider throughput, channel condition, and the like.

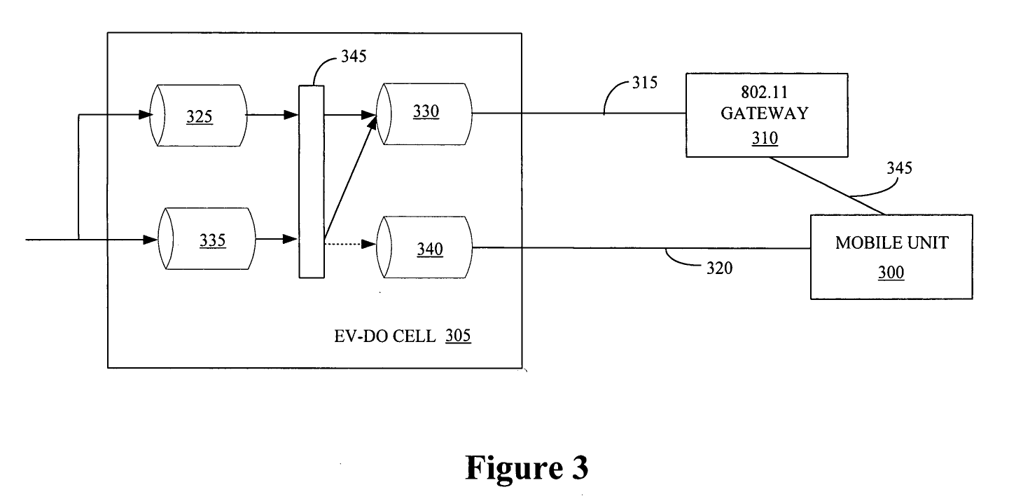

FIG. 3 conceptually illustrates one exemplary embodiment of a vertical handoff of a mobile unit 300 from an EV-DO cell 305 to a gateway 310. In the illustrated embodiment, the mobile unit 300 may provide a notification to the EV-DO cell 305 when the mobile unit 300 decides to switch to the 802.11 gateway 310. The notification message may include the IP-address of the EV-DO interface of the 802.11 gateway 310. In response to receiving the notification message, the EV-DO cell 305 starts to send downstream IP packets for the mobile unit 300 over an EV-DO link 315 to the specified 802.11 gateway 310, instead of sending the downstream packets over the direct EV-DO link 320 to the mobile unit 300. In one embodiment, the IP packets are kept intact (i.e., the IP header in the packets is not changed). In the illustrated embodiment, the EV-DO cell 305 maintains queues 325, 330 for the wireless telecommunication link 315 and queues 335, 340 for the wireless telecommunication link 320. The queue 335 may be used for holding IP packets and the queues 330, 340 are for holding Radio Layer Protocol (RLP) frames. The RLP frame is the unit of the EV-DO link scheduling, and each IP packet may be split into several RLP frames. The queue 325 may be used for holding IP packets belonging to the connections for the 802.11-only mobiles units (which are not shown in FIG. 3) attached to the 802.11 gateway 310.

The vertical handoff may include downlink handoffs, uplink handoffs, or any combination thereof. For a downlink handoff, a queue mapping module 345 maps the IP packet queue 335 for the mobile unit 300 to the RLP frame queue 330 for the 802.11 gateway 310. Depending on the system architecture, the queue 325, the IP packet queue 335, the RLP frame queues 330, 340, and/or the queue mapping module 345 may or may not reside in the same network entity. In any case, the notification message should be delivered to the module 345 that is responsible for the mapping between queues 325, 330, 335, 340.

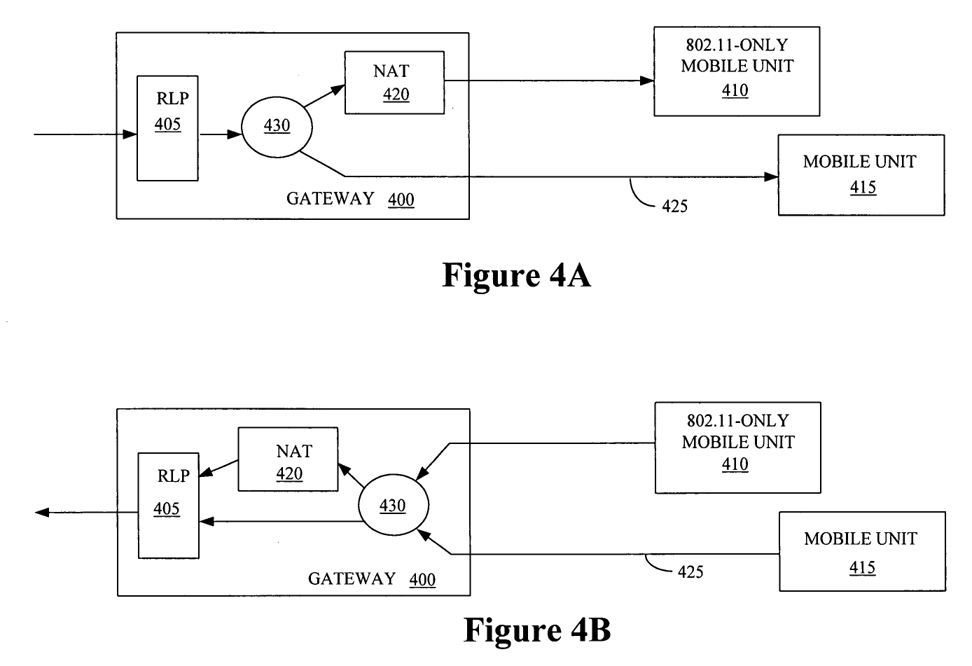

FIG. 4A conceptually illustrates one exemplary embodiment of an 802.11 gateway 400 that may be used for a downlink handoff. At the 802.11 gateway 400, an RLP protocol layer 405 assembles received RLP frames (received from the EV-DO base station) to rebuild the original IP packets. The obtained IP packets may be treated differently depending on whether they are intended for a single-radio (e.g. 802.11-only) mobile unit 410 or a dual-radio mobile unit 415. In the illustrated embodiment, the 802.11 gateway 400 runs a Network Address Translation (NAT) function 420 to support the 802.11-only mobile unit 410. The IP packets belonging to the 802.11 mobile unit 410 each have the IP address of the EV-DO interface of the gateway 400 as the destination address in the downstream IP packets. The NAT 420 converts the destination address to the IP address of the mobile unit 410, which is assigned by the 802.11 gateway via DHCP (Dynamic Host Configuration Protocol). In contrast, the IP packets belonging to the dual-radio mobile unit 415 contain the IP addresses of the dual-radio mobile unit 415 (which are the IP addresses of the mobiles' EV-DO links) as the destination addresses. For such packets, the gateway 400 bypasses the NAT function 420 and forwards the packets over the 802.11 link 425 between the 802.11 gateway 400 and the mobile unit 415. Routing information for the mobile units 410, 415 may be included in a routing module 430.

Referring back to FIG. 3, for an uplink handoff, the EV-DO cell 305 may route IP packets provided by the gateway 310 to a target address. In the illustrated embodiment, the EV-DO cell 305 does not conduct ingress filtering.

FIG. 4B conceptually illustrates one exemplary embodiment of the 802.11 gateway 400 that may be used for an uplink handoff. In the illustrated embodiment, the dual-radio mobile unit 415 sends upstream IP packets (each packet with its own IP address as a source address) over the 802.11 link 425 when the mobile unit 415 decides to switch its uplink traffic to the 802.11 gateway 400. At the 802.11 gateway 400, the routing module 430 checks the source address of the incoming IP packets to determine if they should go through the NAT module 420 or not. The IP packets from the dual-radio mobile unit 415 are directly sent to the EV-DO cell, while the packets from the 802.11-only mobile unit 410 are masqueraded by the NAT module 420 before being sent over the EV-DO uplink. The IP packets from mobile unit 410 are given by the NAT module 420 as their source address the IP address of the gateway 400.

Referring back to FIG. 3, a vertical handoff may also be used to hand off the mobile unit 300 from the gateway 310 to the EV-DO cell 305. In one embodiment, the mobile unit 300 sends a notification message to the EV-DO cell 305 (or more specifically to the queue mapping module in the EV-DO cell) to initiate the vertical handoff back to the EV-DO link 320 from the 802.11 link 315. In response to receiving the notification message, the mapping module 345 in the EV-DO cell 305 modifies the mapping to restore the mapping between the IP packet queue 335 and the RLP frame queue 340 to the original state (i.e., connecting the IP packet queue 335 to the RLP frame queue 340 for the EV-DO link 320). As a result, new downstream IP packets (including those already in the IP packet queue 335) are delivered to the mobile unit 300 over the direct EV-DO link 320.

In the illustrated embodiment, the 802.11 gateway 310 may not need to change anything and may continue to forward received IP packets (which have been sent to the 802.11 gateway 310 because their RLP frames are already in the RLP frame queue 330 before the vertical handoff becomes effective) to the mobile unit 300. After that, the 802.11 gateway 310 simply does not receive any additional packets from the EV-DO cell 305 destined for the mobile unit 300 or packets from the mobile unit 300 that are destined for the EV-DO cell 305. However, the gateway 310 should not interpret this as an indication that the mobile unit 300 has moved out of its coverage region or has terminated its connection. In particular, the gateway 310 should maintain all the logical connections for the mobile unit 300 as well as all relevant call state information in case the data traffic is switched back through the gateway 310.

For uplink switching, the mobile unit 300 may stop sending IP packets over the 802.11 link 345 and start to use the EV-DO uplink 320. The 802.11 gateway 310 again does not need to do anything. In one embodiment, the 802.11 gateway 310 may not be informed of the handoff decision.

In one embodiment, both the 802.11 link 315 and the EV-DO link 320 can carry traffic concurrently. For the downstream traffic, this can be achieved by mapping both RLP frame queues 330, 340 to the IP packet queue 335 for the mobile unit 300. For the upstream traffic, the mobile unit 300 may send some IP packets via the 802.11 gateway 310 while sending other packets over the EV-DO link 320. Note that for both uplink and downlink transmission, an entire IP packet should be sent over the same link for proper RLP operation and reassembly of the IP packet. Since some scheduling mechanisms for the EV-DO downlink allow only one active connection at a time, the feature may not make much impact for downlink in current EV-DO systems. However, it may provide some link diversity in the downlink channel and the mobile unit 300 may experience a channel quality which is the larger of its direct link 320 and the link 315 from the 802.11 gateway 310 to the EV-DO cell 305. In addition, the feature of transmitting over both links 315, 320 concurrently may be relevant to other cellular network technologies which allow multi-user transmissions on the downlink. Meanwhile, the current EV-DO system uses circuit-type connections for the uplink, so that concurrent transmission over dual links 315, 320 may enhance the total data throughput for the mobile unit 300.

The vertical handoff techniques described herein may be transparent to Mobile IP when the 802.11 gateway 310 acts as a relay between the mobile unit 300 and the umbrella cell 305. Therefore, the Mobile IP signaling and routing may not be affected by our scheme, which is only effective within the same umbrella cell that a mobile is currently connected to. Mobile IP may become effective when the mobile unit 300 moves from the umbrella cell 305 to another umbrella cell (not shown). In one embodiment, Mobile IP may be used for ‘horizontal handoffs’ (e.g., handoffs between umbrella cells).

When multiple hotspot cells exist within a single umbrella cell, two kinds of handoff scenarios may be possible depending on whether the hotspot cells overlap with each other or not. If the hotspot cells do not overlap with each other, the mobile unit 300 may first switch to the umbrella cell 305 when it moves out of the coverage of a hotspot cell served by the gateway 310. The mobile unit 300 may make a new switching decision when it enters the coverage of another hotspot cell (not shown). If the two adjacent hotspots have overlapping coverage, the mobile unit 300 may directly switch from one hotspot to the other hotspot. In the latter case, the mobile unit 300 sends a notification message to the umbrella cell 305 including the IP address of the new hotspot that it wants to connect to. When a hotspot cell is located in-between two umbrella cells, it is possible that the umbrella cell for the mobile unit 300 may be different from that of the hotspot that the mobile unit 300 wants to associate with. In such a case, the notification message from the mobile unit 300 may be refused by the umbrella cell, because the intended 802.11 gateway is not connected to that umbrella cell. Instead, the mobile unit has to switch to the new umbrella cell first, and then it can switch to the intended 802.11 gateway.

Although the previous discussion assumed that the mobile unit 300 makes the switching (or cell selection) decision, the present invention is not so limited. In one alternative embodiment, the EV-DO cell 305 may perform the switching decision. One benefit of this alternative is that it does not require the proprietary client software for the cell selection algorithm and the handoff protocol at the mobile unit 300. In this approach, the mobile unit 300 entrance to the hotspot cell is detected by the 802.11 gateway 310 via the standard IEEE 802.11 connection establishment procedure. Similar to the case when the mobile unit 300 makes the switching decision, the dual-radio mobile unit 300 may use the IP address of its EV-DO interface for the IP address of the 802.11 interface. The detection is reported to the umbrella EV-DO cell 305. This report contains the IP address of the mobile unit 300 and that of the 802.11 gateway 310. More specifically, the report is delivered to the decision making module (not shown) in the umbrella EV-DO cell 305. In one embodiment, the decision module compares the channel quality of the direct EV-DO link 320 with that of the EV-DO link 315, while other factors may be additionally considered. When a mobile unit 300 leaves the coverage of an 802.11 cell, the departure should be reported to the umbrella EV-DO cell 305 by the 802.11 gateway 310.

In the illustrated embodiment, the handoff for the downlink traffic is enforced by the queue mapping module 345. However, there may be no direct way for the umbrella EV-DO cell 305 to force mobile unit 300 to choose a certain uplink path. One indirect way might be to manipulate the uplink channel quality information sent by the EV-DO cell 305 to the mobile unit 300. To move the mobile unit 300 to the 802.11 link 315, one could artificially decrease the reported channel quality value, while increasing it back to its true value to move the mobile unit 300 back to the EV-DO link 320. In this embodiment, the mobile unit 300 may run a cell-selection algorithm based on knowledge of the respective channel qualities and may not arbitrarily select one technology over the other.

The RLP frames transmitted over the links 315, 320 may carry certain information indicating that they are a portion of a particular IP packet. In that case, ‘frame-level switching’ may be feasible. Frame-level switching means that, when link switching occurs, the RLP frames that are not sent yet can be transferred over the new link. This may allow for faster cell switching than the IP packet-level switching described above. For frame-level switching, the 802.11 gateway 310 should not reassemble the received RLP frames but should instead send them to the mobile unit 300, which may reassemble the RLP frames by combining the frames received over both links 315, 320. In one embodiment, the transmission from gateway 310 to the mobile unit 300 may entail encapsulating the received RLP frames into IP packets. The current EV-DO RLP frames do not carry the information necessary to identify IP address, whereas 802.16 MAC frames do contain such information.

If the mobile unit 300 sends and/or receives traffic via the 802.11 gateway 310 and does not use its EV-DO link 320 for an extended period of time, the EV-DO link 320 may suffer a timeout. To prevent this, the EV-DO link timeout timers for the mobile unit 300 may be specially treated. Alternatively, some packets may be periodically sent over the direct EV-DO link 320 to avoid timeout. If the mobile unit 300 switches back to the direct EV-DO link 320 after an extensive period, the transmission history information managed by a proportional fair scheduling (EV-DO scheduling algorithm) implemented in the EV-DO cell 305 may be empty. The lack of transmission history may cause the mobile unit 300 to receive unfairly high bandwidth under the proportional fair scheduling. The history information for such mobiles may be set to avoid such phenomenon. For example, data traffic received by the mobile unit 300 (or sent to the mobile unit 300) through the 802.11 gateway 310 may be stored (or otherwise kept track of) and scheduler parameters may be adjusted as if this data had in fact been transmitted over the direct link 320.

In one embodiment, RLP frames that are already in the queues 330, 340 may be transferred over the associated links 315, 320 even after cell switching occurs. If the RLP frame queue 330, 340 is very large, this may cause out of order delivery or even packet losses, as some frames are still received over the previous link, which is potentially slower than the new link or may be disconnected before all frames are transferred. To prevent these, the size of the RLP frame queues 330, 340 may be set to a relatively small value. Alternatively, in case of frame-level switching, the frames belonging to the mobile unit 300 may be moved to the RLP frame queue 330, 340 of the new link 315, 320.

One or more embodiments of the vertical handoff technique described above may have a number of advantages over conventional practice. The vertical handoff technique may hand off between concurrent communication links and therefore may provide a seamless vertical handoff mechanism between a direct connection from a mobile terminal to a 3G wide-area base station and an indirect connection that uses a mobile gateway as a relay. The connections are concurrently active and data traffic can be re-routed quickly and in an efficient manner, thereby achieving larger per-user throughputs through route diversity. Since both connections are concurrently active, there is no service interruption and the performance degradation during handoff that results from interruptions may be reduced. Data traffic can be routed over different paths for the uplink and the downlink channel. In other words, the uplink traffic can use the direct path between the mobile station and the umbrella cell and the downlink traffic can use the mobile gateway as a relay between the umbrella cell and the mobile station. In one embodiment, the hand off is achieved by changing the queue mapping instead of changing of the IP routing table, which is the case of the typical conventional handoff mechanisms. Switching communication links using the queue mapping may allow lower overhead and faster switching. The vertical handoff mechanism may also work with macro mobility management algorithms such as Mobile IP and may be transparent to these algorithms.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of wireless telecommunication using a wireless telecommunications network that includes a mobile unit and first and second wireless connection points, the first and second wireless connection points being communicatively coupled, comprising:
forming a first wireless communication link between the mobile unit and the first wireless connection point;
forming, concurrently with the first wireless communication link, a second wireless communication link between the mobile unit and the second wireless connection point; and
selecting at least one of the first and second wireless communication links.

2. The method of claim 1, wherein forming the first wireless communication link with the first wireless connection point comprises forming the first wireless communication link with an access point according to at least one of a Bluetooth protocol and an 802 protocol.

3. The method of claim 1, wherein forming the second wireless communication link with the second wireless connection point comprises forming the second wireless communication link with at least one of an Evolution Data Optimized (EV-DO) base station, a Universal Mobile Telecommunication System (UMTS) base station, a Global System for Mobile telecommunications (GSM) base station, and a High Speed Downlink Packet Access (HSDPA) base station.

4. The method of claim 1, wherein selecting at least one of the first and second wireless communication links comprises selecting at least one of the first and second wireless communication links based on at least one available network resource.

5. The method of claim 4, wherein selecting at least one of the first and second wireless communication links based on at least one available network resource comprises selecting at least one of the first and second wireless communication links based upon at least one of a loading, a battery life, and a channel condition.

6. The method of claim 1, wherein selecting at least one of the first and second wireless communication links comprises selecting at least one of the first and second wireless communication links based on at least one quality of service requirement.

7. The method of claim 6, wherein selecting at least one of the first and second wireless communication links based on at least one quality of service requirement comprises selecting at least one of the first and second wireless communication links based on a throughput.

8. The method of claim 1, wherein selecting at least one of the first and second wireless communication links comprises selecting at least one of the first and second wireless communication links for a downlink.

9. The method of claim 8, wherein selecting at least one of the first and second wireless communication links for the downlink comprises selecting a queue associated with the first or second wireless communication link.

10. The method of claim 9, comprising providing downlink traffic to the selected queue.

11. The method of claim 1, wherein selecting at least one of the first and second wireless communication links comprises selecting at least one of the first and second wireless communication links for an uplink.

12. The method of claim 11, wherein selecting at least one of the first and second wireless communication links for the uplink comprises providing uplink traffic over the selected one of the first and second wireless communication links.

13. The method of claim 1, wherein selecting at least one of the first and second wireless communication links comprises selecting the first wireless communication link for a first portion of data and selecting the second wireless communication link for a second portion of data.

14. The method of claim 13, wherein selecting the first wireless communication link for a first portion of data and selecting the second wireless communication link for a second portion of data comprises selecting the first wireless communication link for downlink traffic and selecting the second wireless communication link for uplink traffic.

15. The method of claim 1, comprising performing a handoff to the at least one selected wireless communication link.

16. The method of claim 15, wherein performing the handoff comprises performing the handoff in response to receiving a notification message.

17. The method of claim 16, comprising providing the notification message.

18. The method of claim 15, wherein performing the handoff comprising modifying at least one queue mapping.

19. The method of claim 18, wherein modifying at least one queue mapping comprises modifying at least one mapping of at least one queue associated with the selected wireless telecommunication link.

20. The method of claim 18, wherein modifying at least one queue mapping comprises modifying at least one mapping between an Internet Protocol packet queue and a Radio Link Protocol frame queue.

21. The method of claim 1, comprising:
forming, concurrently with the first and second wireless communication links, a third wireless communication link with a third wireless connection point; and
selecting at least one of the first, second, and third wireless communication links.

22. The method of claim 21, wherein the first and the third wireless connection points provide wireless connectivity to overlapping geographic areas, and wherein selecting at least one of the first, second, and third wireless communications links comprises selecting the first or the third wireless communication link.

23. The method of claim 22, comprising performing a handoff to the selected first or third wireless communication link.

24. The method of claim 23 wherein performing the handoff comprises modifying a queue mapping.
